(19) United States
(12) Patent Application Publication
(10) Pub. No.: US 2006/0210759 A1
(43) Pub. Date: Sep. 21, 2006

(54) Optical information storage medium

(75) Inventors: Han-Yi Chang, Taipei County (TW); Cheng-Yuan Tsai, Tzu-Bei City (TW); Tsai-Chu Hsiao, Chung-Li City (TW)

Correspondence Address: BIRCH STEWART KOLASCH & BIRCH, PO BOX 747, FALLS CHURCH, VA, 22040-0747, US

(73) Assignee: PRODISC TECHNOLOGY INC.

(21) Appl. No.: 11/142,534

(22) Filed: Jun. 2, 2005

(30) Foreign Application Priority Data
Mar. 15, 2005 (TW) 094107935

(51) Int. Cl. B32B 3/02

(52) U.S. Cl. 428/64.4

(57) ABSTRACT

An optical information storage medium includes a first substrate, a first recording layer, a first reflective layer, a spacer layer, a second recording layer, a second reflective layer and a second substrate. In this case, the first recording layer is disposed above the first substrate. The first reflective layer is disposed above the first recording layer. The spacer layer is disposed above the first reflective layer. The second recording layer is disposed above the spacer layer. The second reflective layer is disposed above the second recording layer. The second substrate is disposed above the second reflective layer and the second substrate has a groove, wherein the depth of the groove is smaller than 100 nm.

### BACKGROUND OF THE INVENTION

1. Field of Invention

The present invention relates to an optical information storage medium and, in particular, to an optical information storage medium with high storage density.

2. Related Art

Due to the progress of multimedia, the demands of storage medium in 3C products, i.e. computer, communication and consumer, regarding to storage density and capacity are increasing. Conventional storage medium could be divided into magnetic information storage medium and optical information storage medium. Optical information storage medium is greatly applied to electronic products, it includes read-only CD (CD-ROM), write-once CD (CD-R), rewritable CD (CD-RW), read-only DVD (DVD-ROM), write-once DVD (DVD-R), rewritable DVD (DVD-RW, DVD+RW) and random-access DVD (DVD-RAM), etc.

In order to save much more audio, video and other information, how to increase the storage capacities of CD and DVD have been an important target in this industry. Due to the advantage of high storage capacity, DVD will have higher potential than CD being applied to electronic products. DVD has different configuration such as single-side single-layer, dual-side single-layer, single-side dual-layer and dual-side dual-layer, and the storage capacity ranges from 4.7 GB to 17 GB.

Due to the properties of high storage capacity (8.5 GB) and write-once, the application of single-side dual-layer DVD-R is more and more important. As shown in FIG. 1, conventional single-side dual-layer DVD-R 10 includes a first substrate 11, a first recording stack layer (L₀) 12, a spacer layer 13, a second recording stack layer (L₁) 14 and a second substrate 15. The first recording stack layer (L₀) 12 and the second recording stack layer (L₁) 14 are respectively formed on the data side of the first substrate 11 and the second substrate 15. The spacer layer 13 is disposed between the first recording stack layer (L₀) 12 and the second recording stack layer (L₁) 14. Generally speaking, the first recording stack layer (L₀) 12 and the second recording stack layer (L₁) 14 respectively includes a recording layer and a reflective layer. When reading out data stored in DVD-R, laser beam will pass through the first substrate 11 and focus on the first recording stack layer (L₀) 12 or pass through the spacer layer 13 and focus on the second recording stack layer (L₁) 14.

Conventionally, single-side dual-layer DVD-R 20 may be manufactured by photo-polymerization process or bonding process. These two manufacturing process will be illustrated herein below.

Photo-polymerization process: as shown in FIG. 2, a first organic dye layer 22 and a first reflective layer 23 are sequentially spin-coated on a pre-grooved first substrate 21. A photo-setting resin is formed on the first reflective layer 23, then pressing a pre-grooved disc stamper 24 thereon. By a photo curing, the photo-setting resin will be solidified to be a spacer layer 26. Then, removing the disc stamper 24 and groove will be formed on the spacer layer 26. A second organic dye layer 27 and a second reflective layer 28 are sequentially spin-coated on the spacer layer 26. Finally, a second substrate 29 is bonded and the manufacturing processes are completed.

Bonding process: as shown in FIG. 3, a first organic dye layer 22 and a first reflective layer 23 are sequentially spin-coated on a pre-grooved first substrate 21. A second reflective layer 28 and a second organic dye layer 27 are sequentially spin-coated on a pre-grooved second substrate 29. Then, the first reflective layer 23 and the second organic dye layer 27 are bonded by a photo-setting resin. By a photo curing, the photo-setting resin will be solidified to be a spacer layer 26 and the manufacturing processes are completed.

Due to additional press and removal process steps, photo-polymerization process will induce a lower production yield and a higher cost caused by the disc stamper 24. So the manufacturing cost by photo-polymerization process will be higher than by bonding process. How to apply bonding process to manufacture a single-side dual-layer DVD-R has been an important target in this industry.

The depth of the groove on the first substrate 21 and the second substrate 29 of DVD-R manufactured by prior bonding process range respectively from 100 nm to 160 nm. The thickness of the dye layer of the recording layer is about 70 nm to 130 nm. However, the production yield of manufactured DVD-R will be quite low under such specification. When reading out data, pick-up head could not get an effective “blank” signal and induce disc drive fail to proceed any read out and write in operation.

Therefore, find out a proper specification and which is suitable for manufacturing single-side dual-layer DVD-R by low-cost bonding process has been an essential issue in this industry.

It is therefore an important subject of the present invention to provide an optical information storage medium for solving the problems of getting an effective “blank” signal as the optical information storage medium is manufactured by bonding process.

### SUMMARY OF THE INVENTION

In view of the foregoing, the present invention is to provide an optical information storage medium, in which single-side dual-layer DVD-R manufactured by bonding process could get an effective “blank” signal in order to let DVD-R be easily read out and wrote in by disc drive.

To achieve the above, an optical information storage medium according to the present invention includes a first substrate, a first recording layer, a first reflective layer, a spacer layer, a second recording layer, a second reflective layer and a second substrate. In the present invention, the first recording layer is disposed above the first substrate. The first reflective layer is disposed above the first recording layer. The spacer layer is disposed above the first reflective layer. The second recording layer is disposed above the spacer layer. The second reflective layer is disposed above the second recording layer. The second substrate is disposed above the second reflective layer and the second substrate has a groove, wherein the depth of the groove is smaller than 100 nm.

As mentioned above, the depth of the groove on the second substrate of an optical information storage medium according to the present invention is smaller than 100 nm. Comparing with the prior art, the smaller depth on the second substrate of an optical information storage medium according to the present invention could get a better and effective “blank” signal and reflection ratios of the first recording stack layer and the second recording stack layer are respectively greater than 16% for easily being read out and wrote in by general disc drive. That is, an optical information storage medium according to the present invention is suitable for mass production and meets the reading & writing requirement of general disc drive.

### BRIEF DESCRIPTION OF THE DRAWINGS

The present invention will become more fully understood from the detailed description given herein below illustration only, and thus is not limitative of the present invention, and wherein:

FIG. 1 is a schematic view showing a conventional single-side dual-layer DVD-R;

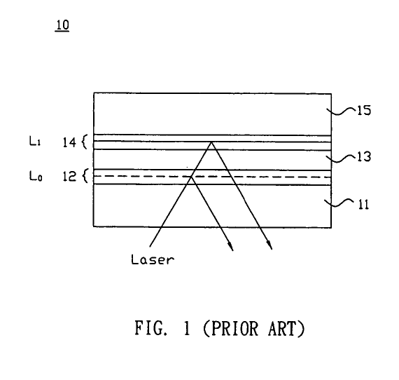

FIG. 2 is a schematic view showing a photo-polymerization process applied to a conventional single-side dual-layer DVD-R;

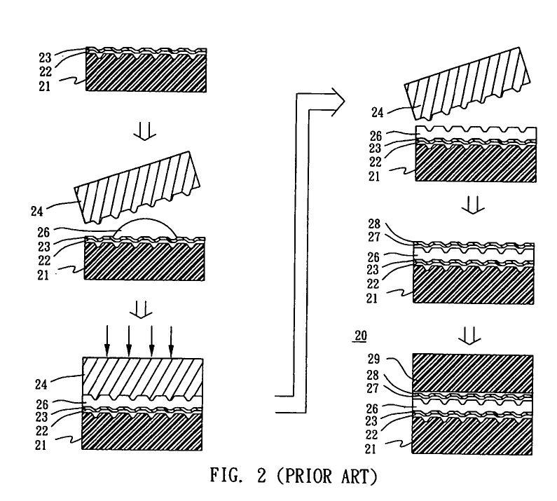

FIG. 3 is a schematic view showing a bonding process applied to a conventional single-side dual-layer DVD-R;

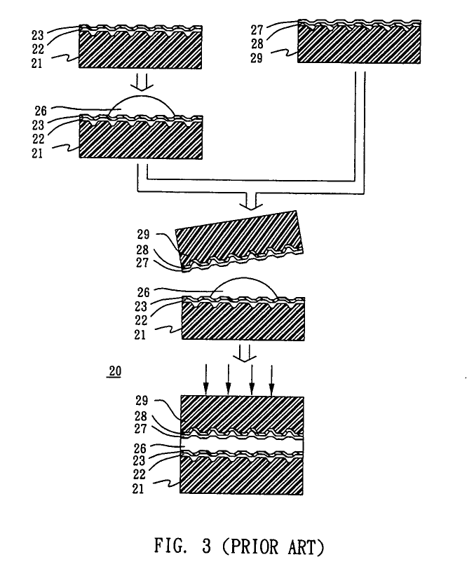

FIG. 4 is a schematic view showing an optical information storage medium according to the present invention; and

FIG. 5 is a schematic view showing the second substrate of an optical information storage medium according to the present invention.

### DETAILED DESCRIPTION OF THE INVENTION

The present invention will be apparent from the following detailed description, which proceeds with reference to the accompanying drawings, wherein the same references relate to the same elements.

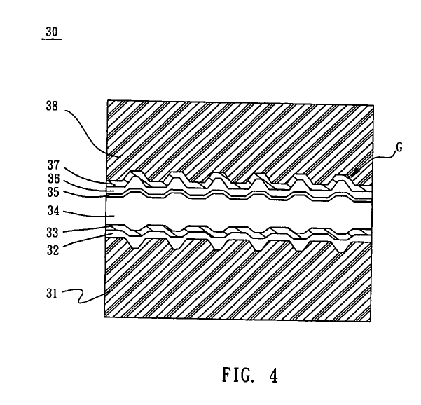

As shown in FIG. 4, an optical information storage medium 30 includes a first substrate 31, a first recording layer 32, a first reflective layer 33, a spacer layer 34, a second recording layer 36, a second reflective layer 37 and a second substrate 38. In this embodiment, the optical information storage medium 30 is a write-once single-side dual-layer DVD and manufactured by bonding process.

The first recording layer 32 is disposed above the first substrate 31. The first recording layer 32 may be made of organic dye or inorganic material. In this embodiment, the first recording layer 32 is made of organic dye and formed by spin-coating process.

The first reflective layer 33 is disposed above the first recording layer 32. The first reflective layer 33 may be a semi-reflective layer, which is made of metal or its alloy, for example but not limited to silver or silver alloy, aluminum or aluminum alloy, gold or gold alloy. The formation process of the first reflective layer 33 may be sputtering or evaporation.

The spacer layer 34 is disposed above the first reflective layer 33. The spacer layer 34 is made of photo-setting resin, which is liquid state at the beginning and photo-cured by radiation to be a solid resin.

In this embodiment, the optical information storage medium 30 may further include a buffer layer 35 disposed between the second recording layer 36 and the spacer layer 34. The buffer layer 35 is made of silicon nitride, silicon oxide or zinc sulfide-silicon oxide.

The second recording layer 36 is disposed above the spacer layer 34. The second recording layer 36 may be made of inorganic material or organic dye, and formed by sputtering, evaporation or spin-coating process, etc. The thickness of the second recording layer 36 ranges from 140 nm to 220 nm.

The second reflective layer 37 is disposed above the second recording layer 36. The second reflective layer 37 may be a film of semiconductor or conductive alloy.

The second substrate 38 is disposed above the second reflective layer 37. The first substrate 31 and the second substrate 38 may be made of polycarbonate (PC) with excellent optical property and chemical stability. The first substrate 31 and the second substrate 38 may be other transparent material. In this embodiment, the first substrate 31 and the second substrate 38 is formed by injection molding of polycarbonate to form the pre-grooved substrate. The depth of the groove G of the second substrate 38 is smaller than 100 nm, and is preferably 20 nm to 80 nm. The optical information storage medium 30 is read out, wrote in or erased data from, for example but not limited to, “on-groove” or “in-groove” on the first substrate 31 and the second substrate 38.

In order to let the first recording stack layer L₀ and the second recording stack layer L₁ of single-side dual-layer DVD-R be easily read out by disc drive, reflection ratios of the first recording stack layer and the second recording stack layer should be respectively greater than 16%. Under the circumstance of the same depth of the reflective layer and the recording layer, the deeper the groove on the second substrate 38, the lower reflection ratio be gotten. Therefore, the present invention reduces the depth of the groove on the second substrate 38 to meet the requirement of reflection ratio to disc drive.

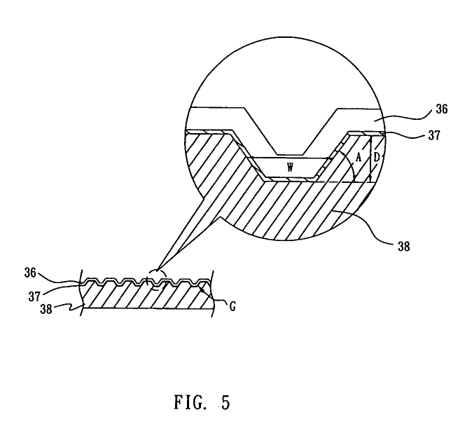

As shown in FIG. 5, the groove G has a depth D and a half-height width W (range from 200 nm to 520 nm), and the wall of the groove G is tilted an angle A (range from 25 to 75 degree) to the bottom of the groove G. When the depth of the groove G is about 30 nm, the half-height width W of the groove G is about 400 nm, the angle A is about 30 degree, and the second recording layer 36 is 160 nm in thickness of AZO dye, the reflection ratios of the first recording stack layer L₀ and the second recording stack layer L₁ of optical information storage medium manufactured by bonding process will be greater than 16% and get an effective “blank” signal, for example “push pull” signal, normalized wobble signal (NWS), wobble to noise ratio (WNR).

When the depth of the groove G is about 80 nm, the half-height width W of the groove G is about 350 nm, the angle A is about 55 degree, and the second recording layer 36 is 160 nm in thickness of AZO dye, the reflection ratios of the first recording stack layer L₀ and the second recording stack layer L₁ of optical information storage medium manufactured by bonding process will also be greater than 16% and get an effective “blank” signal.

In summary, the depth of the groove on the second substrate of an optical information storage medium according to the present invention is smaller than 100 nm. Comparing with the prior art, the smaller depth on the second substrate of an optical information storage medium according to the present invention could get a better and effective “blank” signal and reflection ratios of the first recording stack layer and the second recording stack layer are respectively greater than 16% for easily being read out and wrote in by general disc drive. That is, an optical information storage medium according to the present invention is suitable for mass production and meets the reading & writing requirement of general disc drive.

Although the present invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the present invention.

What is claimed is:

1. An optical information storage medium, comprising:
a first substrate;
a first recording layer, disposed above the first substrate;
a first reflective layer, disposed above the first recording layer;
a spacer layer, disposed above the first reflective layer;
a second recording layer, disposed above the spacer layer;
a second reflective layer, disposed above the second recording layer; and
a second substrate, disposed above the second reflective layer and the second substrate has a groove, wherein the depth of the groove is smaller than 100 nm.

2. An optical information storage medium according to claim 1, wherein the storage medium is a write-once single-side dual-layer DVD.

3. An optical information storage medium according to claim 1, wherein the first reflective layer and the second recording layer are bonded to each other by the spacer layer.

4. An optical information storage medium according to claim 1, wherein the thickness of the second recording layer is about 140 nm to 220 nm.

5. An optical information storage medium according to claim 1, wherein the half-height width of the groove is about 200 nm to 520 nm.

6. An optical information storage medium according to claim 1, wherein the wall of the groove is tilted an angle to the bottom of the groove and the angle is about 25 to 75 degree.

7. An optical information storage medium according to claim 1, wherein the depth of the groove is about 20 nm to 80 nmn.

8. An optical information storage medium according to claim 1, further comprising a buffer layer, disposed between the second recording layer and the spacer layer.

9. An optical information storage medium according to claim 8, wherein the buffer layer is made of silicon nitride, silicon oxide or zinc sulfide-silicon oxide.
